(19) United States
(12) Patent Application Publication
(10) Pub. No.: US 2023/0415412 A1
(43) Pub. Date: Dec. 28, 2023

(54) Three-Dimensional Shaping Stage And Three-Dimensional Shaping Apparatus

(71) Applicant: SEIKO EPSON CORPORATION, Tokyo (JP)

(72) Inventors: Takafumi SAMESHIMA, Matsumoto (JP); Taki HASHIMOTO, Shiojiri (JP); Masayuki GOZU, Ina (JP)

(21) Appl. No.: 18/341,001

(22) Filed: Jun. 26, 2023

(30) Foreign Application Priority Data
Jun. 27, 2022 (JP) 2022-102438

(51) Int. Cl. B29C 64/245; B29C 64/295

(52) U.S. Cl. CPC B29C 64/245; B29C 64/295; B33Y 30/00

(57) ABSTRACT

A three-dimensional shaping stage includes: a placement portion that includes an opening and a reference surface whose flatness is adjusted; a shaping stage that is placed at the reference surface so as to cover the opening and that includes a shaping surface at which shaping layers are stacked; a heating unit that is disposed below the shaping stage and that is configured to heat the shaping stage; a pressing unit configured to press the heating unit against the shaping stage via the opening; and a holding unit configured to relatively hold the shaping stage to the reference surface.

The present application is based on, and claims priority from JP Application Serial Number 2022-102438, filed Jun. 27, 2022, the disclosure of which is hereby incorporated by reference herein in its entirety.

### BACKGROUND

### 1. Technical Field

The present disclosure relates to a three-dimensional shaping stage and a three-dimensional shaping apparatus.

### 2. Related Art

JP-A-2020-146927 discloses a shaping apparatus in which a plurality of planar heaters that heat a shaping stage are provided at the shaping stage.

When the shaping stage is placed at the heaters, flatness of the heaters may influence flatness of the shaping stage, which may influence shaping accuracy.

### SUMMARY

According to a first aspect of the present disclosure, a three-dimensional shaping stage is provided. The three-dimensional shaping stage includes: a placement portion that includes an opening and a reference surface whose flatness is adjusted; a shaping stage that is placed at the reference surface so as to cover the opening and that includes a shaping surface at which shaping layers are stacked; a heating unit that is disposed below the shaping stage and that is configured to heat the shaping stage; a pressing unit configured to press the heating unit against the shaping stage via the opening; and a holding unit configured to relatively hold the shaping stage to the reference surface.

According to a second aspect of the present disclosure, a three-dimensional shaping apparatus is provided. The three-dimensional shaping apparatus includes the three-dimensional shaping stage; and a nozzle configured to discharge a shaping material to the shaping surface.

### BRIEF DESCRIPTION OF THE DRAWINGS

FIG. 1 shows a schematic configuration of a three-dimensional shaping apparatus.

FIG. 2 is a perspective view showing a schematic configuration of a flat screw.

FIG. 3 is a schematic plan view of a barrel.

FIG. 4 is a perspective view of a three-dimensional shaping stage.

FIG. 5 is a top view of the three-dimensional shaping stage.

FIG. 6 is a cross-sectional view of a cross section VI-VI that is a cross section perpendicular to a Y direction shown in FIG. 5.

FIG. 7 is an exploded perspective view of a heating unit.

FIG. 8 is a perspective view of a second holding unit and a vicinity thereof.

FIG. 9 is a perspective view of a biasing unit and a vicinity thereof.

### DESCRIPTION OF EXEMPLARY EMBODIMENTS

### A. First Embodiment

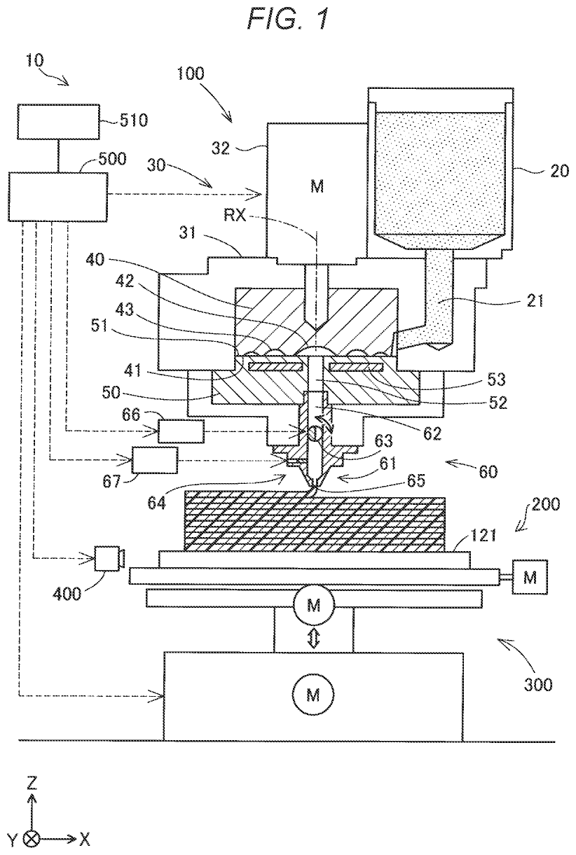

FIG. 1 shows a schematic configuration of a three-dimensional shaping apparatus 10. FIG. 1 shows arrows indicating X, Y, and Z directions orthogonal to one another. The X direction and the Y direction are directions parallel to a horizontal plane. The Z direction is a direction parallel to a vertical direction. The X, Y, and Z directions in FIG. 1 and X, Y, and Z directions in other drawings indicate the same directions. When an orientation is specified, a positive direction that is a direction indicated by an arrow is set as “+”, a negative direction that is a direction opposite to the direction indicated by the arrow is set as “−”, and the positive and negative signs are used in combination for direction notation. In the following description, a +Z direction is referred to as “upper”, and a −Z direction is referred to as “lower”.

The three-dimensional shaping apparatus 10 includes a shaping unit 100, a three-dimensional shaping stage 200, a position change unit 300, a sensor 400, and a control unit 500.

The control unit 500 is a control device that controls an overall operation of the three-dimensional shaping apparatus 10. The control unit 500 is implemented by a computer including one or more processors, a memory, and an input and output interface that inputs and outputs signals from and to an outside. The control unit 500 exerts various functions such as a function of executing a shaping process for shaping a three-dimensional shaped object by executing by the processor a program or a command read from a main storage device. Instead of being implemented by the computer, the control unit 500 may be implemented by a configuration in which a plurality of circuits for implementing at least a part of functions are combined.

Under control of the control unit 500, the shaping unit 100 discharges a shaping material obtained by plasticizing a material in a solid state into a paste shape onto the three-dimensional shaping stage 200 that is a base of the three-dimensional shaped object. The shaping unit 100 includes a material supply unit 20, a plasticizing unit 30, and a discharging unit 60.

The material supply unit 20 supplies a material for generating the shaping material to the plasticizing unit 30. The material supply unit 20 is implemented by, for example, a hopper. A pellet-shaped or powder-shaped material is housed in the material supply unit 20. As the material, thermoplastic resin such as polypropylene resin (PP), polyethylene resin (PE), or polyacetal resin (POM) is used. A communication path 21 that couples the material supply unit 20 to the plasticizing unit 30 is provided below the material supply unit 20. The material supply unit 20 supplies the material to the plasticizing unit 30 via the communication path 21.

The plasticizing unit 30 plasticizes at least a part of the material supplied from the material supply unit 20, generates a paste-shaped shaping material having fluidity, and guides the generated shaping material to the discharging unit 60. Here, the term “plasticizing” is a concept including melting, and means a change from a solid state to a state having fluidity. Specifically, in a case of a material in which glass transition occurs, the term plasticizing means making a temperature of the material equal to or higher than a glass transition point. In a case of a material in which no glass transition occurs, the term plasticizing means making the temperature of the material equal to or higher than a melting point. The plasticizing unit 30 includes a flat screw 40, a screw case 31, a driving motor 32, and a barrel 50.

The flat screw 40 is housed in the screw case 31. An upper surface side of the flat screw 40 is coupled to the driving motor 32. The flat screw 40 is rotated in the screw case 31 by a rotational driving force generated by the driving motor 32. An axial direction of a rotation axis RX of the flat screw 40 is a direction along the Z direction. A rotational speed of the flat screw 40 is controlled by controlling a rotational speed of the driving motor 32 by the control unit 500. The flat screw 40 may be driven by the driving motor 32 via a speed reducer. The flat screw 40 is also referred to as a rotor or a screw.

The barrel 50 is installed on a −Z direction side of the flat screw 40. A barrel upper surface 51 that is an upper surface of the barrel 50 faces a flat screw lower surface 41 that is a lower surface of the flat screw 40. A communication hole 52, which communicates with a flow path 62 of the discharging unit 60, is formed in a center of the barrel 50. A plasticizing heater 53 is provided inside the barrel 50. A temperature of the plasticizing heater 53 is controlled by the control unit 500.

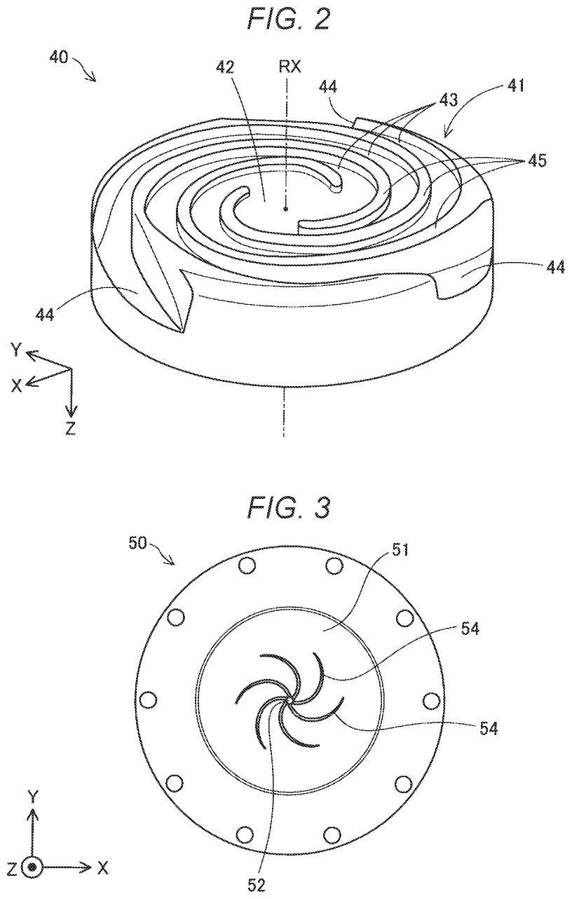

FIG. 2 is a perspective view showing a schematic configuration of the flat screw 40. The flat screw 40 has a substantially columnar shape whose length in a direction along the rotation axis RX is smaller than a length in a direction perpendicular to the rotation axis RX. In the flat screw lower surface 41, spiral groove portions 43 are formed around a central portion 42. The groove portions 43 communicate with a material feeding port 44 formed in a side surface of the flat screw 40. The material supplied from the material supply unit 20 is supplied to the groove portions 43 through the material feeding port 44. The groove portions 43 are formed by being separated by ridge portions 45. Although FIG. 2 shows an example in which three groove portions 43 are formed, the number of the groove portions 43 may be one or two or more. The groove portion 43 is not limited to the spiral shape, and may have a helical or involute curved shape, or a shape that extends so as to draw an arc from the central portion 42 toward an outer periphery.

FIG. 3 is a schematic plan view of the barrel 50. A plurality of guide grooves 54 are formed around the communication hole 52 of the barrel upper surface 51. One end of each guide groove 54 is coupled to the communication hole 52, and extends from the communication hole 52 toward an outer periphery of the barrel upper surface 51 in a spiral shape. The one end of the guide groove 54 may not be coupled to the communication hole 52. Further, the guide grooves 54 may not be formed in the barrel 50.

The material supplied to the groove portions 43 of the flat screw 40 flows along the groove portions 43 while being plasticized in the groove portions 43 and is guided to the central portion 42 of the flat screw 40 as the shaping material by the rotation of the flat screw 40 and the heating of the plasticizing heater 53. The paste-shaped shaping material that flows into the central portion 42 and that exhibits fluidity is supplied to the discharging unit 60 via the communication hole 52. All types of substances that constitute the shaping material may not be plasticized in the plasticizing unit 30. The shaping material may be converted into a state having fluidity as a whole by plasticizing at least a part of types of substances among the substances that constitute the shaping material.

The discharging unit 60 shown in FIG. 1 discharges the shaping material. The discharging unit 60 includes a nozzle 61, the flow path 62, a flow rate adjustment unit 63, and a suction unit 64.

The nozzle 61 is coupled to the communication hole 52 of the barrel 50 through the flow path 62. The nozzle 61 discharges the shaping material generated in the plasticizing unit 30 from a discharging port 65 at a tip end of the nozzle 61 toward the three-dimensional shaping stage 200. A heater, which prevents a decrease in the temperature of the shaping material discharged onto the three-dimensional shaping stage 200, may be disposed around the nozzle 61.

The flow rate adjustment unit 63 changes an opening degree of the flow path 62 by being rotated in the flow path 62. The flow rate adjustment unit 63 is implemented by a butterfly valve. The flow rate adjustment unit 63 is driven by a first driving unit 66 under the control of the control unit 500. The first driving unit 66 is implemented by, for example, a stepping motor. The control unit 500 adjusts a flow rate of the shaping material that flows from the plasticizing unit 30 to the nozzle 61, that is, the flow rate of the shaping material discharged from the nozzle 61 by controlling a rotational angle of the butterfly valve by the first driving unit 66. The flow rate adjustment unit 63 adjusts the flow rate of the shaping material, and controls on/off of an outflow of the shaping material.

The suction unit 64 is coupled between the flow rate adjustment unit 63 and the discharging port 65 in the flow path 62. When discharging the shaping material from the nozzle 61 is stopped, by temporarily suctioning the shaping material in the flow path 62, the suction unit 64 prevents a tailing phenomenon in which the shaping material drips from the discharging port 65 like pulling a thread. The suction unit 64 is implemented by a plunger. The suction unit 64 is driven by a second driving unit 67 under the control of the control unit 500. The second driving unit 67 is implemented by, for example, a stepping motor, and a rack-and-pinion mechanism that converts a rotational force of the stepping motor into a translational motion of a plunger.

When stopping discharging the shaping material from the nozzle 61, the control unit 500 first controls the flow rate adjustment unit 63 to turn off the outflow of the shaping material, and then controls the suction unit 64 to suction the shaping material. When restarting discharging the shaping material from the nozzle 61, the control unit 500 controls the suction unit 64 to feed out the shaping material suctioned by the suction unit 64, and then controls the flow rate adjustment unit 63 to turn on the outflow of the shaping material.

The three-dimensional shaping stage 200 is disposed at a position facing the discharging port 65 of the nozzle 61. The three-dimensional shaping apparatus 10 shapes the three-dimensional shaped object by discharging the shaping material from the discharging unit 60 toward a shaping surface 121 of the three-dimensional shaping stage 200 to stack shaping layers. Details of the three-dimensional shaping stage 200 will be described later.

The position change unit 300 changes a relative position between the nozzle 61 and the three-dimensional shaping stage 200. The position change unit 300 moves the three-dimensional shaping stage 200 with respect to the nozzle 61. The change in the position of the nozzle 61 relative to the three-dimensional shaping stage 200 is also simply referred to as movement of the nozzle 61. The position change unit 300 is implemented by a three-axis positioner that moves the stage in three axial directions including the X, Y, and Z directions by driving forces from three motors. Each motor is driven under the control of the control unit 500. The position change unit 300 may not have the configuration of moving the three-dimensional shaping stage 200, but have a configuration of moving the nozzle 61 instead of moving the three-dimensional shaping stage 200. Further, the position change unit 300 may have a configuration of moving both the three-dimensional shaping stage 200 and the nozzle 61.

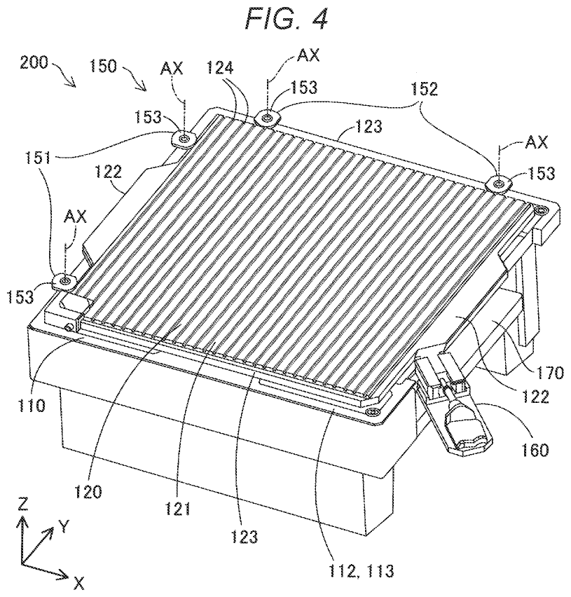

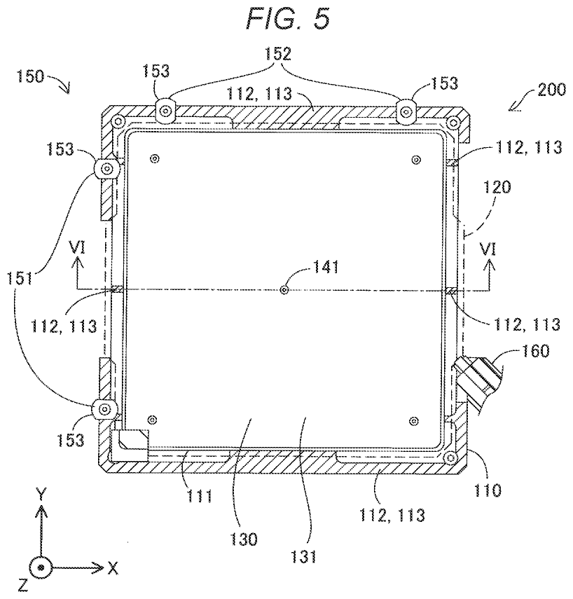

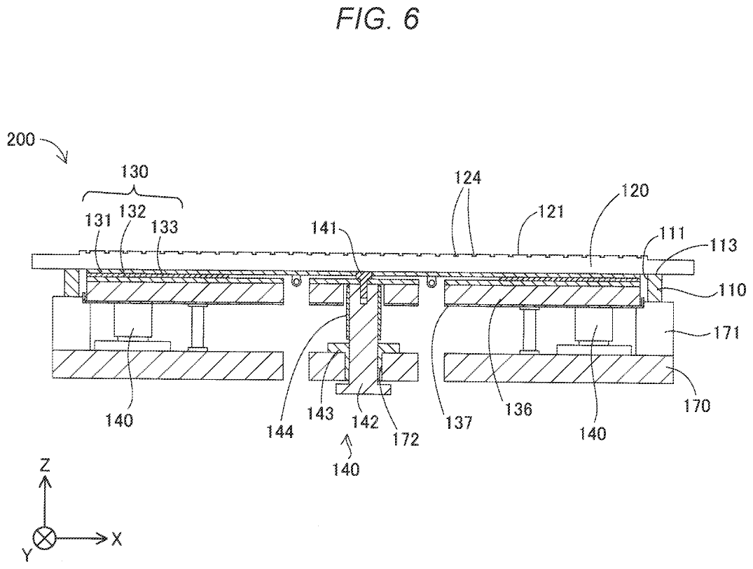

In the following description, the three-dimensional shaping stage 200 will be described. FIG. 4 is a perspective view of the three-dimensional shaping stage 200. FIG. 5 is a top view of the three-dimensional shaping stage 200. FIG. 6 is a cross-sectional view of a cross section VI-VI that is a cross section perpendicular to the Y direction shown in FIG. 5. The three-dimensional shaping stage 200 includes a placement portion 110, a shaping stage 120, a heating unit 130, a pressing unit 140, a holding unit 150, and a biasing unit 160.

As shown in FIG. 5, the placement portion 110 includes an opening 111, convex portions 112, and reference surfaces 113. The placement portion 110 has a frame shape when viewed from the Z direction. The opening 111 is inside a frame of the placement portion 110. The convex portion 112 is a portion of the placement portion 110 where a height of an upper surface in the Z direction is larger than that of a periphery of the convex portion 112. The reference surface 113 is the upper surface of the convex portion 112. In FIG. 5, the reference surface 113 is hatched in order to show the reference surface 113 in an easy-to-understand manner. A height of the reference surface 113 in the Z direction is adjusted such that flatness of the reference surface 113 is reduced. The flatness of the reference surface 113 is preferably, for example, 100 μm or less.

As shown in FIG. 6, a support portion 170 is provided below the placement portion 110 and the heating unit 130. The placement portion 110 is fixed on a pillar 171 fixed to an upper surface of the support portion 170 such that an upper surface of the placement portion 110 is parallel to the X direction and the Y direction. The pillar 171 is formed of a material hard to be deformed by heating such as Invar.

The shaping stage 120 is placed at the reference surface 113 so as to cover the opening 111. As shown in FIG. 5, the shaping stage 120 is in contact with a part of the reference surface 113. As shown in FIG. 4, the shaping stage 120 includes the shaping surface 121, first portions 122, and second portions 123.

The shaping surface 121 is a surface at which the shaping material discharged from the nozzle 61 is stacked. A plurality of grooves 124 are formed at predetermined intervals in the shaping surface 121. In the embodiment, the groove 124 is formed in a direction along the Y direction. The groove 124 may not be formed in the shaping stage 120.

The first portion 122 is a portion where the shaping stage 120 is in contact with the reference surface 113, and is a portion where a handle is formed. The first portion 122 is provided on an end portion of the shaping stage 120 on a +X direction side and an end portion of the shaping stage 120 on a −X direction side. The second portion 123 is a portion where the shaping stage 120 is in contact with the reference surface 113, and is a portion where the handle is not formed. The second portion 123 is provided on an end portion of the shaping stage 120 on a +Y direction side and an end portion of the shaping stage 120 on a −Y direction side. As shown in FIG. 5, areas of the reference surfaces 113 of an end portion of the placement portion 110 on the +X direction side and an end portion of the placement portion 110 on the −X direction side are smaller than areas of the reference surfaces 113 of an end portion of the placement portion 110 on the +Y direction side and an end portion of the placement portion 110 on the −Y direction side. Therefore, a contact area between the first portion 122 and the reference surface 113 is smaller than a contact area between the second portion 123 and the reference surface 113.

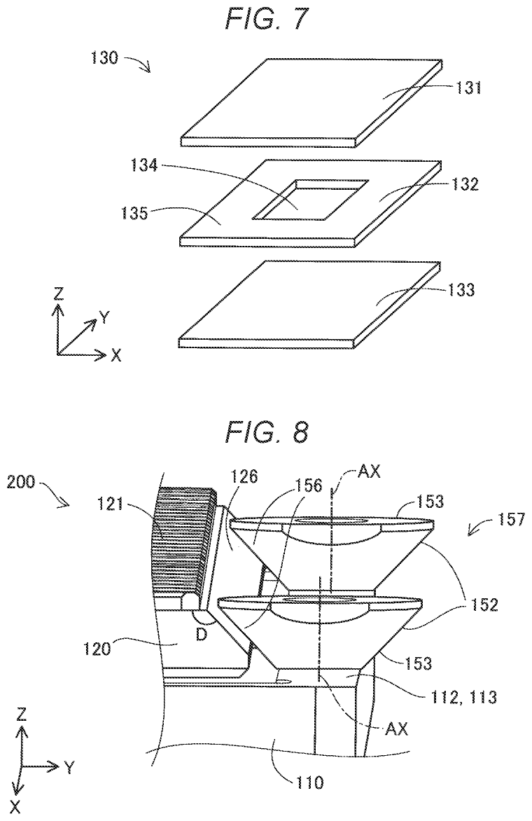

FIG. 7 is an exploded perspective view of the heating unit 130. The heating unit 130 includes a first aluminum plate 131, a rubber heater 132, and a second aluminum plate 133. The first aluminum plate 131 and the second aluminum plate 133 have a plate shape. In the embodiment, the rubber heater 132 has a plate shape in which a rectangular hole is provided in a center. The heating unit 130 includes a first region 134 and a second region 135. The first region 134 is a region not including the rubber heater 132 when viewed from a direction perpendicular to the shaping surface 121, that is, the Z direction. The second region 135 is a region that surrounds the first region 134 and that includes the rubber heater 132 when viewed from the direction perpendicular to the shaping surface 121, that is, the Z direction. The first aluminum plate 131, the rubber heater 132, and the second aluminum plate 133 are overlapped in an order of the second aluminum plate 133, the rubber heater 132, and the first aluminum plate 131 from the −Z direction to the +Z direction.

The heating unit 130 heats the shaping stage 120. As shown in FIG. 6, the heating unit 130 is disposed below the shaping stage 120, and is provided in the opening 111 of the placement portion 110 so as not to be in contact with the placement portion 110. The heating unit 130 and the reference surface 113 are separated from each other. Below the heating unit 130, a heat-insulating material 136 for preventing heat of the heating unit 130 from transmitting downward, and a heat-insulating material receiver 137 that supports the heat-insulating material 136 are provided.

The pressing unit 140 is provided below the heating unit 130. The pressing unit 140 presses the heating unit 130 against the shaping stage 120 from below via the opening 111. The pressing unit 140 includes a positioning screw 141, a column 142, a spacer 143, and a spring 144. The positioning screw 141 is fixed to the first aluminum plate 131. The column 142 is provided below the second aluminum plate 133. The column 142 is fixed to the heating unit 130 by screwing the positioning screw 141 in a screw hole provided in an upper surface of the column 142. A part of the column 142 is located inside a hole 172 provided in the support portion 170. The spacer 143 is provided in the hole 172 of the support portion 170 so as to fill a gap between the column 142 and the support portion 170. The spring 144 is provided between the second aluminum plate 133 and the spacer 143 on an outer periphery of the column 142. The heating unit 130 is biased upward by an elastic force of the spring 144, and is pressed against the shaping stage 120 from below. A plurality of pressing units 140 may be provided below the heating unit 130 instead of one.

The holding unit 150 shown in FIG. 4 relatively holds the shaping stage 120 to the reference surfaces 113. The holding unit 150 includes a first holding unit 151 and a second holding unit 152. The first holding unit 151 is provided at the end portion of the placement portion 110 on the −X direction side. The second holding unit 152 is provided at the end portion of the placement portion 110 on the +Y direction side. The first holding unit 151 and the second holding unit 152 are each implemented by eccentric pins 153. Each eccentric pin 153 has a pin rotation axis AX. An axial direction of the pin rotation axis AX is a direction along a Z axis. The pin rotation axis AX is provided at a position deviated from a center of the eccentric pin 153. In the eccentric pin 153, the pin rotation axis AX is rotatably provided as a rotation axis.

FIG. 8 is a perspective view of the second holding unit 152 and a vicinity thereof. A side surface of the shaping stage 120 includes a first inclined surface 126 inclined such that an end portion on a lower side is farther away from the shaping surface 121 than an end portion on an upper side in a horizontal direction. An angle D defined by the shaping surface 121 and the first inclined surface 126 is preferably 95° or more and 135° or less on an inner side of the shaping stage 120. The holding unit 150 includes second inclined surfaces 156 facing the first inclined surface 126 of the shaping stage 120. The second inclined surfaces 156 of the holding unit 150 are brought into contact with the first inclined surface 126 of the shaping stage 120 to relatively hold the shaping stage 120 to the reference surface 113.

The holding unit 150 includes a position adjustment mechanism 157 that adjusts a position of the shaping stage 120 in a direction along the shaping surface 121. The position of the shaping stage 120 in the direction along the shaping surface 121 is adjusted by rotating the eccentric pins 153 around the pin rotation axes AX by a user. Since the pin rotation axis AX is provided at the position deviated from the center of the eccentric pin 153, by rotating the eccentric pins 153 around the pin rotation axes AX, a distance between the pin rotation axes AX and portions of the second inclined surfaces 156 in contact with the first inclined surface 126 is changed. Therefore, the position of the shaping stage 120 in the direction along the shaping surface 121 is changed by rotating the eccentric pins 153 around the pin rotation axes AX. A position of the end portion of the shaping stage 120 on the −X direction side is adjusted by rotating the eccentric pins 153 of the first holding unit 151 around the pin rotation axes AX by the user. A position of the end portion of the shaping stage 120 on the +Y direction side is adjusted by rotating the eccentric pins 153 of the second holding unit 152 around the pin rotation axes AX by the user. The holding unit 150 adjusts the position of the shaping stage 120 in the direction along the shaping surface 121 such that an angle defined by a direction of the grooves 124 of the shaping stage 120 and a side surface of the placement portion 110 along the X direction is an angle close to 90°.

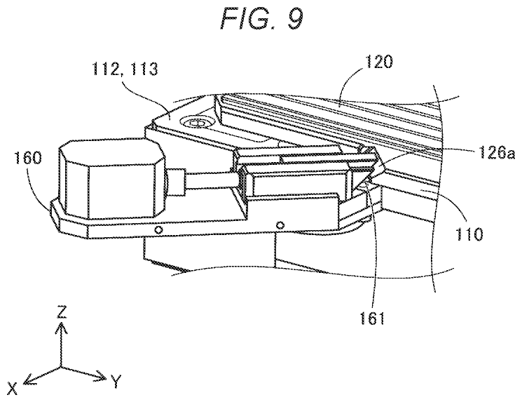

FIG. 9 is a perspective view of the biasing unit 160 and a vicinity thereof. The biasing unit 160 biases the shaping stage 120 toward the holding unit 150. The biasing unit 160 is provided at an end portion of the three-dimensional shaping stage 200 on the +X direction side. A first inclined surface 126a is provided on a side surface of the shaping stage 120 on the +X direction side. An angle defined by the shaping surface 121 and the first inclined surface 126a is preferably 95° or more and 135° or less on the inner side of the shaping stage 120. The biasing unit 160 includes a third inclined surface 161 facing the first inclined surface 126a. The biasing unit 160 biases the shaping stage 120 toward the holding unit 150 by bringing the third inclined surface 161 into contact with the first inclined surface 126a. The three-dimensional shaping stage 200 may not include the biasing unit 160.

The sensor 400 shown in FIG. 1 measures a distance between the sensor 400 and the shaping stage 120 at a plurality of points while relatively moving with respect to the three-dimensional shaping stage 200 in a direction along a side surface of the placement portion 110. The sensor 400 is, for example, a laser displacement meter. In the embodiment, the sensor 400 is movable in a direction along the side surface of the placement portion 110. In the embodiment, the sensor 400 is movable in a direction along the X direction or a direction along the Y direction. Before the three-dimensional shaping apparatus 10 shapes the three-dimensional shaped object, the sensor 400 measures a distance from the sensor 400 to the side surface of the shaping stage 120 while moving in the direction along the side surface of the placement portion 110 under the control of the control unit 500. When the sensor 400 is moved in the direction along the X direction, the sensor 400 measures a distance from the sensor 400 to a side surface of the shaping stage 120 along the X direction. When the sensor 400 is moved in the direction along the Y direction, the sensor 400 measures a distance from the sensor 400 to a side surface of the shaping stage 120 along the Y direction. When the sensor 400 measures the distance to the side surface of the shaping stage 120 while moving in the direction along one side surface of the placement portion 110 and the distance to the side surface of the shaping stage 120 is changed exceeding a predetermined threshold, the control unit 500 displays on a display unit 510 coupled to the control unit 500 a warning message.

According to the three-dimensional shaping apparatus 10 in the first embodiment described above, the shaping stage 120 is placed at the reference surfaces 113 whose flatness is adjusted, the heating unit 130 is pressed from below by the pressing unit 140, and the shaping stage 120 is relatively held to the reference surfaces 113 by the holding unit 150. Since the shaping stage 120 is not placed at the heating unit 130, it is possible to reduce an influence by flatness of the heating unit 130 on flatness of the shaping stage 120. As a result, it is possible to reduce chances that the flatness of the heating unit 130 influences shaping accuracy.

Since the handle is formed at the first portion 122 of the shaping stage 120, a temperature of the first portion 122 is easier to decrease than that of the second portion 123 because of heat dissipation from the handle. In the embodiment, since the contact area between the first portion 122 and the reference surface 113 is smaller than the contact area between the second portion 123 and the reference surface 113, an amount of heat that moves from the first portion 122 to the placement portion 110 can be made smaller than an amount of heat that moves from the second portion 123 to the placement portion 110. Therefore, a temperature distribution of the shaping stage 120 can be made more uniform.

In the embodiment, since the heating unit 130 includes the first region 134 not including the rubber heater 132 when viewed from the direction perpendicular to the shaping surface 121, a temperature of a central portion of the heating unit 130 can be lowered. Accordingly, an increase in the temperature of the central portion of the heating unit 130 can be prevented, and the temperature distribution of the shaping stage 120 can be made more uniform.

In the embodiment, the side surface of the shaping stage 120 includes the first inclined surface 126, and the angle D defined by the shaping surface 121 and the first inclined surface 126 is preferably 95° or more and 135° or less on the inner side of the shaping stage 120. Therefore, as compared with a case where the angle D defined by the shaping surface 121 and the first inclined surface 126 is larger than 135° on the inner side of the shaping stage 120, when the shaping stage 120 is heated by the heating unit 130, it is possible to prevent a situation in which the shaping stage 120 bites into the holding unit 150 and the shaping stage 120 and the holding unit 150 cannot be separated from each other.

In the embodiment, since the holding unit 150 includes the second inclined surfaces 156 facing the first inclined surface 126 of the shaping stage 120, it is possible to prevent the shaping stage 120 from floating in the +Z direction.

In the embodiment, since the holding unit 150 includes the position adjustment mechanism 157, the user can adjust the position of the shaping stage 120 in the direction along the shaping surface 121. Further, in the embodiment, the three-dimensional shaping apparatus 10 includes the sensor 400 that measures the distance between the sensor 400 and the shaping stage 120 while moving in the direction along the side surface of the placement portion 110. When the sensor 400 measures the distance to the side surface of the shaping stage 120 while moving in the direction along one side surface of the placement portion 110 and the distance to the side surface of the shaping stage 120 is changed exceeding the predetermined threshold, the control unit 500 displays on the display unit 510 the warning message. Therefore, the user can know that the side surface of the placement portion 110 and the side surface of the shaping stage 120 are not parallel to each other, that is, that the angle defined by the direction of the grooves 124 of the shaping stage 120 and the side surface of the placement portion 110 along the X direction is not close to 90°. Further, the user adjusts the holding unit 150 based on the distance to the side surface of the shaping stage 120 measured by the sensor 400, so that the position of the shaping stage 120 in the direction along the shaping surface 121 can be adjusted such that the angle defined by the direction of the grooves 124 of the shaping stage 120 and the side surface of the placement portion 110 along the X direction is an angle close to 90°. As a result, the shaping material can be accurately disposed with respect to the grooves 124.

### B. Other Embodiments

(B-1) In the above-described embodiment, the sensor 400 is movable in the direction along the side surface of the placement portion 110. On the contrary, the position of the sensor 400 may be fixed, and the three-dimensional shaping stage 200 may be movable in the direction along the side surface of the placement portion 110.

(B-2) In the above-described embodiment, the side surface of the shaping stage 120 may not include the first inclined surface 126, and the holding unit 150 may not include the second inclined surfaces 156.

(B-3) In the above-described embodiment, the holding unit 150 may not include the position adjustment mechanism 157.

(B-4) In the above-described embodiment, the heating unit 130 may not include the first region 134 and the second region 135.

(B-5) In the above-described embodiment, regarding the shaping stage 120, the contact area between the first portion 122 and the reference surface 113 may not be smaller than the contact area between the second portion 123 and the reference surface 113.

(B-6) In the above-described embodiment, the three-dimensional shaping apparatus 10 may not include a part or all of the shaping unit 100, the position change unit 300, the sensor 400, and the control unit 500.

### C. Other Aspects

The present disclosure is not limited to the embodiments described above, and can be implemented in various aspects within a range not departing from a gist of the present disclosure. For example, the present disclosure can also be implemented by the following aspects. In order to solve a part or all of problems of the present disclosure, or in order to achieve a part or all of effects of the present disclosure, the technical features in the embodiments described above corresponding to technical features in aspects described below can be replaced or combined as appropriate. Further, unless described as necessary in the present specification, the technical features can be deleted as appropriate.

(1) According to an aspect of the present disclosure, a three-dimensional shaping stage is provided. The three-dimensional shaping stage includes: a placement portion that includes an opening and a reference surface whose flatness is adjusted; a shaping stage that is placed at the reference surface so as to cover the opening and that includes a shaping surface at which shaping layers are stacked; a heating unit that is disposed below the shaping stage and that is configured to heat the shaping stage; a pressing unit configured to press the heating unit against the shaping stage via the opening; and a holding unit configured to relatively hold the shaping stage to the reference surface. According to such an aspect, since the shaping stage is not placed at the heating unit, it is possible to reduce an influence by flatness of the heating unit on flatness of the shaping stage. Therefore, it is possible to reduce chances that the flatness of the heating unit influences shaping accuracy.

(2) In the above-described aspect, a side surface of the shaping stage may include a first inclined surface inclined such that an end portion on a lower side is farther away from the shaping surface than an end portion on an upper side in a horizontal direction, and the holding unit may include a second inclined surface facing the first inclined surface. According to such an aspect, it is possible to prevent the shaping stage from floating in a +Z direction.

(3) In the above-described aspect, an angle defined by the shaping surface and the first inclined surface may be 95° or more and 135° or less on an inner side of the shaping stage. According to such an aspect, when the shaping stage is heated by the heating unit, it is possible to prevent a situation in which the shaping stage bites into the holding unit and the shaping stage and the holding unit cannot be separated from each other.

(4) In the above-described aspect, the three-dimensional shaping stage may further include a biasing unit configured to bias the shaping stage toward the holding unit. According to such an aspect, it is possible to prevent the shaping stage from moving on the reference surface.

(5) In the above-described aspect, the holding unit may include a position adjustment mechanism configured to adjust a position of the shaping stage in a direction along the shaping surface. According to such an aspect, a user can adjust the position of the shaping stage in the direction along the shaping surface.

(6) In the above-described aspect, the heating unit may include a first region not including a rubber heater when viewed from a direction perpendicular to the shaping surface, and a second region that surrounds the first region and that includes the rubber heater when viewed from the direction perpendicular to the shaping surface. According to such an aspect, a temperature distribution of the shaping stage can be made more uniform.

(7) In the above-described aspect, the reference surface and the heating unit may be separated from each other, the shaping stage may include a first portion that is a portion in contact with the reference surface and at which a handle is formed, and a second portion that is a portion in contact with the reference surface and at which the handle is not formed, and a contact area between the first portion and the reference surface may be smaller than a contact area between the second portion and the reference surface. According to such an aspect, an amount of heat that moves from the first portion to the placement portion can be made smaller than an amount of heat that moves from the second portion to the placement portion. Therefore, the temperature distribution of the shaping stage can be made more uniform.

(8) In the above-described aspect, a plurality of grooves may be formed at predetermined intervals in the shaping surface. According to such an aspect, since shaping material is injected into the grooves, the shaping material discharged onto the shaping surface can be easily fixed onto the shaping surface.

(9) According to a second aspect of the present disclosure, a three-dimensional shaping apparatus is provided. The three-dimensional shaping apparatus includes the three-dimensional shaping stage; and a nozzle configured to discharge a shaping material to the shaping surface.

(10) In the above-described aspect, the three-dimensional shaping apparatus may further include a sensor, in which the sensor may measure a distance between the sensor and the shaping stage at a plurality of points while relatively moving with respect to the three-dimensional shaping stage in a direction along a side surface of the placement portion. According to such an aspect, the user can adjust the position of the shaping stage such that the side surface of the placement portion and a side surface of the shaping stage are parallel to each other based on the distance measured by the sensor.

What is claimed is:

1. A three-dimensional shaping stage comprising:
a placement portion that includes an opening and a reference surface whose flatness is adjusted;
a shaping stage that is placed at the reference surface so as to cover the opening and that includes a shaping surface at which shaping layers are stacked;
a heating unit that is disposed below the shaping stage and that is configured to heat the shaping stage;
a pressing unit configured to press the heating unit against the shaping stage via the opening; and
a holding unit configured to relatively hold the shaping stage to the reference surface.

2. The three-dimensional shaping stage according to claim 1, wherein
a side surface of the shaping stage includes a first inclined surface inclined such that an end portion on a lower side is farther away from the shaping surface than an end portion on an upper side in a horizontal direction, and
the holding unit includes a second inclined surface facing the first inclined surface.

3. The three-dimensional shaping stage according to claim 2, wherein
an angle defined by the shaping surface and the first inclined surface is 95° or more and 135° or less on an inner side of the shaping stage.

4. The three-dimensional shaping stage according to claim 2, further comprising:
a biasing unit configured to bias the shaping stage toward the holding unit.

5. The three-dimensional shaping stage according to claim 1, wherein
the holding unit includes a position adjustment mechanism configured to adjust a position of the shaping stage in a direction along the shaping surface.

6. The three-dimensional shaping stage according to claim 1, wherein
the heating unit includes
a first region not including a rubber heater when viewed from a direction perpendicular to the shaping surface, and
a second region that surrounds the first region and that includes the rubber heater when viewed from the direction perpendicular to the shaping surface.

7. The three-dimensional shaping stage according to claim 1, wherein
the reference surface and the heating unit are separated from each other,
the shaping stage includes
a first portion that is a portion in contact with the reference surface and at which a handle is formed, and
a second portion that is a portion in contact with the reference surface and at which the handle is not formed, and
a contact area between the first portion and the reference surface is smaller than a contact area between the second portion and the reference surface.

8. The three-dimensional shaping stage according to claim 1, wherein
a plurality of grooves are formed at predetermined intervals in the shaping surface.

9. A three-dimensional shaping apparatus comprising:
the three-dimensional shaping stage according to claim 1; and
a nozzle configured to discharge a shaping material to the shaping surface.

10. The three-dimensional shaping apparatus according to claim 9, further comprising:
a sensor, wherein
the sensor measures a distance between the sensor and the shaping stage at a plurality of points while relatively moving with respect to the three-dimensional shaping stage in a direction along a side surface of the placement portion.
